(19) United States
(12) Patent Application Publication
(10) Pub. No.: US 2016/0364636 A1
(43) Pub. Date: Dec. 15, 2016

(54) MATRIX JOURNAL

(71) Applicant: John T. Kosinski, II, River Rouge, MI (US)

(72) Inventor: John T. Kosinski, II, River Rouge, MI (US)

(21) Appl. No.: 15/178,732

(22) Filed: Jun. 10, 2016

Related U.S. Application Data
(60) Provisional application No. 62/174,063, filed on Jun. 11, 2015.

(51) Int. Cl. G06K 19/06; G06F 17/30; H04N 1/00; G06K 7/14; B42F 13/22; H04N 1/21

(52) U.S. Cl. CPC G06K 19/06037; B42F 13/22; H04N 1/217; H04N 1/00334; G06K 7/1417; G06K 19/06103; G06F 17/30345; H04N 2201/0081

(57) ABSTRACT

The Matrix Journal System embodies a database record structure in paper form to capture and organize user hand crafted content. This structure enables linking content with other pages, journals, external media and web based content. A unique QR code is entered onto each page when the journal is initially created. Once handwritten data has been entered into the matrix journal, individual pages are scanned and captured in a database. The database preserves a digital version of the hand crafted matrix journal content and the QR codes enable organization and management of the database. The matrix journal includes a binder system having a spline, a plurality of rings, and a plurality of loose-leaf pages disposed on the rings sandwiched between a front and a rear cover. The system enables a 360 degree rotation of the front and rear covers, so that the matrix journal can be used anywhere.

### CROSS-REFERENCE TO RELATED APPLICATIONS

This Application is related to and claims priority to U.S. Provisional Application No. 62/174,063, entitled “Matrix Journal”, by John T. Kosinski II, filed on Jun. 11, 2015.

### FIELD OF USE

The present invention relates to journal-planner organization systems, and more particularly to a paper-based journal-planner organization system that utilizes a database structure with unique machine-readable codes.

### BACKGROUND OF THE INVENTION

The history of the human species has been recorded by handheld writing instruments to convey daily thoughts and events. People living in caves initially scratched pictures on the walls of their dwellings. Eventually, this evolved to pen and paper.

While personal electronic devices such as smart phones, personal digital assistants (PDAs), and tablet computers enjoy widespread use in performing a myriad of tasks, including organizing, scheduling and calendaring functions, many people still prefer to use paper-based systems. A traditional paper-based system has many advantages over electronic devices, including comfort, simplicity and familiarity. Writing with a pen onto a sheet of paper is a process we are all familiar with.

Paper planners provide a user with an incredible amount of flexibility in personalizing note-taking and organization. Ideas flow naturally across the page, diagrams can be drawn as conceptualized, and annotations added in the margins.

However, traditional paper planners have several drawbacks. A paper planner provides limited organization, linking and search capabilities. If the planner is lost, there is no recourse since there is rarely a backup copy. Also, it is virtually impossible to add other types of content to the planner, such as audio, and video. Refill packs for traditional paper planners are not very customizable, and often a user ends up with many unused or wasted pages in the planner.

Prior approaches of integrating paper with digital devices do not enable the flexibility of user-created pages.
U.S. Pat. No. 9,141,698 (Brown et al.) discloses a semantic note-taking system for collecting information, enriching the information, and/or binding the information to services is provided. User-created notes are enriched with labels, context traits, and relevant data to minimize friction in the note-taking process. The note-taking system is directed to collecting unscripted data, adding more meaning and use out of the data, and binding the data to services. Mutable and late-binding to services is also provided to allow private thoughts to be published to a myriad of different applications and services in a manner compatible with how thoughts are processed in the brain. User interfaces and semantic skins are also provided to derive meaning out of notes without requiring a great deal of user input. Linking physical objects to notes are also provided, such as through QR codes.
U.S. Pat. No. 7,469,833 (Kelley et al.) discloses a system for creating and using documents with machine-readable codes. A computer program receives user data provided for one or more fields in an electronic document, generates input data containing the user data and metadata that provides a self-contained description of the user data, encodes the input data into a machine-readable code, and generates a final representation of the electronic document with a display of the machine-readable code. Upon reading the machine-readable code, the metadata can be used to identify a set of fields in a target system to which to assign the user data. In some embodiments, the metadata and the user data can be transformed and sent to a target system. The use of metadata in this manner enables machine-readable codes to maintain a physical representation of data that facilitates transfer of the data back into an electronic environment.
U.S. Pat. No. 7,245,483 (Feague et al.) discloses an integrated personal information management system. In one embodiment, an integrated personal information management system is described that comprises: a receptacle holding at least one paper page that is capable of receiving pen strokes from a digital pen; a digital pen for recording pen strokes when a user writes on a particular paper page; a page identifier for identifying the particular paper page on which the user is writing; and a handheld personal information device in communication with the digital pen and page identifier for processing the recorded pen strokes associated with the particular paper page and displaying the processing results on a display screen.
U.S. Pat. No. 6,674,924 (Wright et al.) discloses an apparatus and method for dynamic routing using dynamic data streams. Dynamic routing using dynamic data streams facilitates the creation of a flexible paper gateway in a digital filing system that provides for receiving, processing and storing document images from a wide variety of sources. When thus implemented, dynamic routing allows the digital filing system to efficiently operate while providing digital filing services to a wide variety of users with different needs. Thus, the system provides for the digital filing and management of paper-based information from receipt at the desktop through an indexing, scanning, image storage and image retrieval process.

And, while this prior art addresses some of these problems, data entry on a PDA remains tedious.

What is needed is a system that enables streamlined semi-automated method for searching, sorting, and linking through a database of loose-leaf pages of handwritten data, the database being used to search and organize the loose-leaf pages using the machine-readable metadata embedded therein.

What is needed is a system that enables a user to create a journal comprised of only the pages needed and in the user's own handwriting. What is needed is a system that will enable the user to create different types of journals into these pages based upon user needs.

What is needed is a system that enables the user to create digital copies of these journal pages while automatically linking the digitized copies based upon pre-printed machine-readable codes. What is needed is a system that enables the user to associate other data with these individual journal pages, such as audio and video data, and images, and location data.

### SUMMARY OF THE INVENTION

The present invention provides a solution that addresses these needs.

The primary purpose of the matrix journal of the present invention is to enable the digital organization of handwritten pages in a database structure using machine-readable metadata. Another purpose of the matrix journal of the present invention is to enable the organization and management of the database by using the metadata.

The matrix journal of the present invention comprises a binder system having a binder spline and a plurality of binder rings, sandwiched between a front cover and a rear cover. The binder system is secured to a front cover and back cover.

The binder system of choice enables a 360 degree rotation of the front and back covers, enabling the matrix journal to be used anywhere. The 360 rotation enables the back cover to provide support for a user writing on the first page, and by reversing the covers the front cover provides support for a user writing on the back of the first page.

The matrix journal also includes a plurality of loose-leaf pages disposed on the binder rings. The binder rings readily lock when in the closed position for retaining the loose-leaf pages and the binder rings are readily opened when a page is to be inserted or removed. Each page includes apertures so that the page is compatible with the binder system.

Each loose-leaf page of the journal includes a machine-readable code unique to the page. The code is entered onto each page when the journal is initially created and includes such information as date, page number, serial number for each journal or page, company name, copyright information, website address, personalized name and contact information, and project name.

Once handwritten data has been entered into the matrix journal, individual pages are scanned into a computer and a database is created. The database saves a digital version of the matrix journal, enabling organization and management of digital versions of the loose-leaf pages.

A method and system to define paper-based relational database record capture using a machine-readable metadata structure, utilizing predefined database forms to create individual pages is now described. Each printed page of the journal contains unique record information in machine-readable code is defined by the database structure. Once captured by the user, the information is converted into digital form. The document with the embedded code thereon is processed and submitted to the database. Using the metadata and the page image, the journal can be reconstructed in digital form. This enables the user to perform a multitude of operations on the journal, including, but not limited to, generating .pdf documents, creating specific notebooks by project, and embedding calendar pages into virtual calendars for history reference. The machine-readable code enables linking the record to other forms of data capture.

The matrix journal of the present invention comprises two basic underlying elements: time and content. The first portion of the journal is a time-based structure having one or more pages per week, depending on the amount of resolution the individual user needs. Each of these pages may be linked through the machine-readable code to the content portion of the journal. The second portion of the journal is for free-flow or task specific information capture.

The journal is designed to reduce unnecessary usage by limiting the paper used to pre-printed forms and only creating pages that are required by the user for the task at hand. The page templates are designed to capture different types of information, including but not limited to: time/date organization, multi-column financial information, drawings, and freeform idea capture.

The word “journal”, as used herein, means a regular record or log of events, activities, or thoughts (either personal, business, or both) that includes daily updates, the updates being dated.

“Machine-readable data”, as used herein, is data or metadata, which is in a format that can be understood by a computer.

The terms “machine-readable data or machine-readable codes” include QR codes, data matrix codes, the Microsoft tag, 2D barcodes, RFID tags, and the like. The indicia are typically graphical representations of information (e.g., data) such as product numbers, package tracking numbers, or personnel identification numbers. The use of indicia readers to input data into a system, rather than manual data entry, results in generally faster and more reliable data entry. The “machine-readable code” of choice is the QR (“quick response”) code.

A “QR code” is the trademark for a type of matrix barcode (or two-dimensional barcode) first designed for the automotive industry in Japan. A barcode is a machine-readable optical label that has information about the item to which it is attached. A QR code uses four standardized encoding modes (numeric, alphanumeric, byte/binary, and kanji) to efficiently store data; extensions may also be used. The QR Code system became popular outside the automotive industry due to its fast readability and greater storage capacity compared to standard UPC barcodes. Applications include product tracking, item identification, time tracking, document management, and general marketing. A QR code includes black modules (square dots) arranged in a square grid on a white background, which can be read by an imaging device (such as a camera) and processed using Reed-Solomon error correction until the image can be appropriately interpreted. The required data are then extracted from patterns present in both horizontal and vertical components of the image.

For a complete understanding of the matrix journal of the present invention, reference is made to the following detailed description and accompanying drawings in which the presently preferred embodiments of the invention are shown by way of example. As the invention may be embodied in many forms without departing from the spirit or essential characteristics thereof, it is expressly understood that the drawings are for purposes of illustration and description only, and are not intended as a definition of the limits of the invention.

### BRIEF DESCRIPTION OF THE DRAWINGS

FIG. 1 depicts the preferred embodiment of the matrix journal of the present invention, a user entering data with a pen into the matrix journal, the matrix journal being disposed in a 180-degree open position for writing on a flat surface.

FIG. 2 depicts the preferred embodiment of the matrix journal of FIG. 1, the matrix journal being disposed in a fully closed position.

FIG. 3 depicts a QR code, the QR code being the machine-readable code of choice for each page of the matrix journal of the present invention.

FIG. 4A depicts a simplified page to be used as a time/date organizer for the matrix journal of the present invention, the page being an index page.

FIG. 4B depicts a simplified page to be used for the matrix journal of the present invention, the page having a predefined layout that is delineated for the entry of narrative writing.

FIG. 4C depicts a simplified page to be used for the matrix journal of the present invention, the page having a predefined layout with rows and columns for the entry of data.

FIG. 4D depicts a simplified page set up to be used for the matrix journal of the present invention, the page having a predefined layout that is blank for the capture of for freeform ideas, drawings and sketches.

FIG. 5 depicts the preferred embodiment for capturing the handwritten data of a user into the matrix journal of FIG. 1.

FIG. 6 depicts the preferred embodiment for capturing the handwritten data the matrix journal of FIG. 5 into the database for subsequent organization and management.

FIG. 7 depicts a simplified flowchart of numerous applications for the matrix journal of FIG. 1.

FIG. 8 is a simplified flowchart for a method of creating, using, and storing the journal pages of the present invention.

FIG. 9 is a simplified flowchart for a method of linking additional content to digital copies of journal pages in a database.

FIG. 10 is a simplified flowchart of a method for the creation and use of the matrix journal of the present invention.

FIG. 11 is a perspective view of a partial section of the binder system of the journal matric of the present invention in a closed position.

FIG. 12 is an end view depicting a binding ring of the binder system of the matrix journal in a closed position, thereby securely retaining all pages positioned therebetween.

FIG. 13 is an end view depicting a binding ring of the binder system of the matrix journal in an open position, enabling the removal or replacement of pages within said binder ring.

FIG. 14A is an end view of the binder and the front and back covers and a page of the matrix journal of the present invention in an open position, said first side of the page moving to rest against a front cover and a back cover, thereby providing a hard surface support enabling use of the matrix journal anywhere.

FIG. 14B is an end view of the binder and the front and back covers and a page of the matrix journal of the present invention in an open position, said second side of said page moving to rest against a back cover and a front cover, thereby providing a hard surface support enabling use of the matrix journal anywhere.

FIG. 14C is an end view of the front and back binder covers and two pages of the matrix journal of the present invention in a 180-degree half-flipped position for lying on a horizontal surface.

### DETAILED DESCRIPTION OF THE PREFERRED EMBODIMENTS

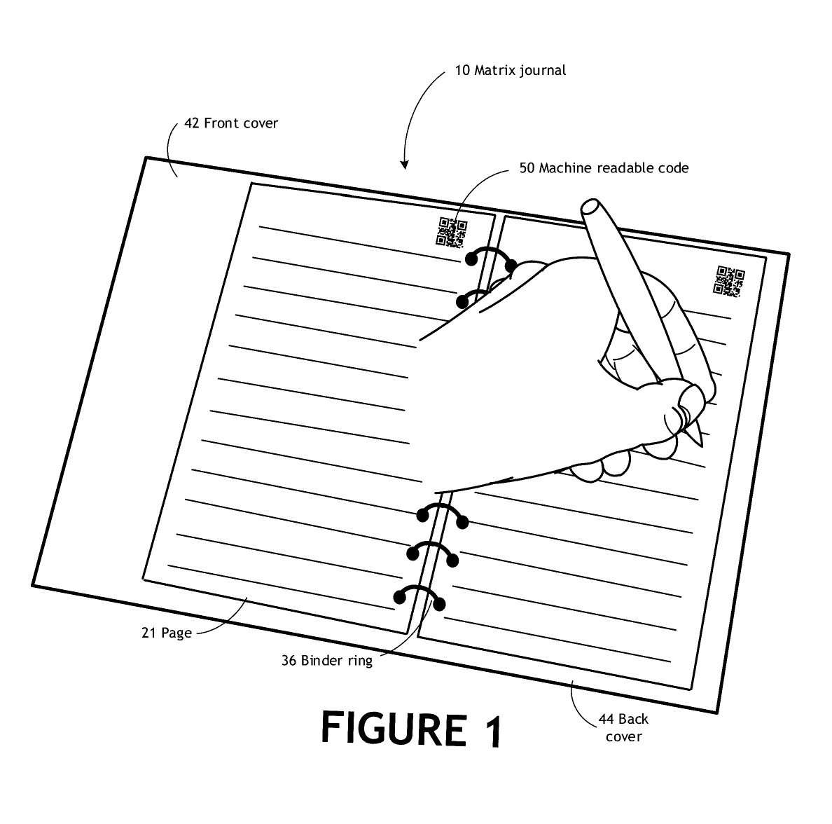

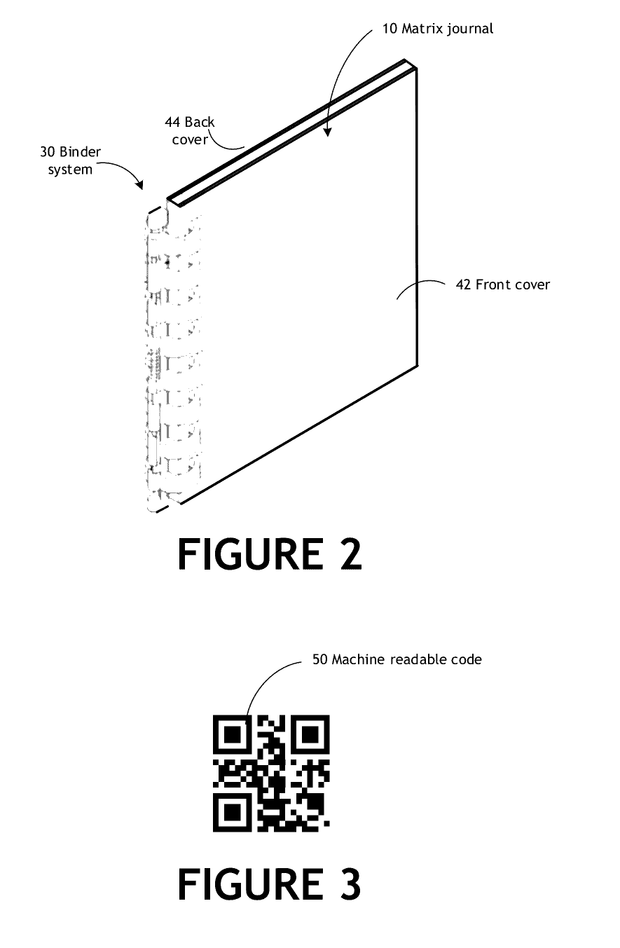

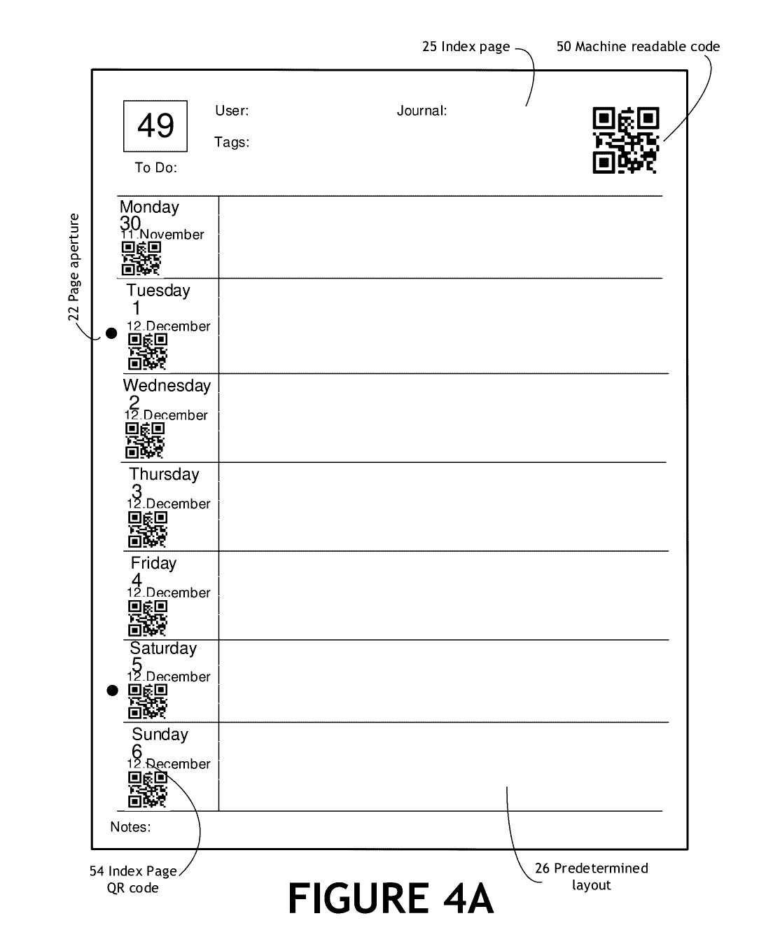

Referring now to the drawings, FIGS. 1 and 2 depict the matrix journal of the present invention [10]. The matrix journal of the present invention [10] comprises a front cover and back cover [44], a binder system [30], pages [21], and at least one machine-readable code [50] on each page [21]. The front and back covers [42 and 44] slide onto the binder system [30] via a plurality of binder rings [36]. The pages [20] include apertures [21] that enable easy insertion, removal, and rearrangement of the pages within the binder system [30]. Each page [21] includes a machine-readable code [50], the machine-readable code [50] includes a metadata unique to each page. The machine-readable code of choice is a quick-response (QR) code (see FIG. 3).

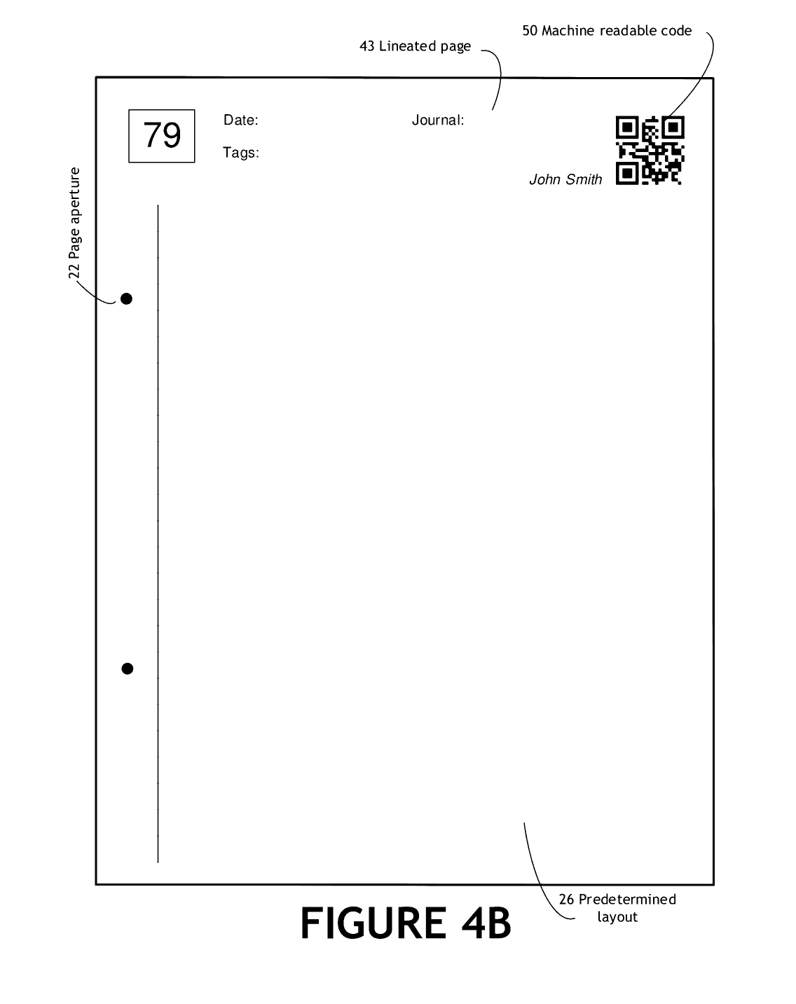

FIGS. 4A, 4B, 4C, and 4D depict a preferred embodiments of various blank pages [20] of the matrix journal of the present invention [10] with a personalized heading. The templates depicted are a layout for a traditional day planner/organizer. The machine-readable code [50] includes page metadata information for the entire page. This metadata includes such information as the page number, the date information for the entire page, and the user name. The machine-readable code [50] contain metadata for each individual date, and any other information the user desires. The metadata in machine-readable codes [50] are linked to other individual journal pages such as that in FIG. 4B. The journal page [43] is an individual date page linked by machine-readable code [50] to an index page [42] in FIG. 4A.

A computer initially prints the blank journal pages, each page including a machine-readable code [50] disposed thereon. The machine-readable code [50] includes metadata unique to each page [21]. Index pages can be used for longer journals to divide the journal into chapters. Machine-readable codes [50] for the first page of each chapter are included on the index page (see FIG. 4A). The pages have predefined layouts [26] depending upon the information to be captured. If the information is a narrative, the pages have lines [27] (see FIG. 4B), if the pages are for financial statements, the pages have rows and columns [29] (see FIG. 4C), and if the pages are for drawings or sketches the pages are primarily blank [28] (see FIG. 4D). The pages have apertures [22] compatible with the particular type of binder system [30] to be used. Numerous other predefined layouts [25] may also be used depending upon the purpose of the matrix journal.

FIG. 4D depicts a preferred embodiment of a blank unlined journal page with a personalized heading. The template depicted is a layout used for free-form idea capture, such as a sketchbook. The machine-readable code [50] includes page metadata including page number, serial number, company name, copyright information, website address, personalized name and contact information, project name, or any other custom tags the user may desire. Blank pages with personalized headings [20] are readily inserted or removed from the binder system [30].

Each page [20] is removable from the binder system [30] for scanning into a database. The database enables management and organization of all of the individual pages once scanned in the original handwriting of one or more users.

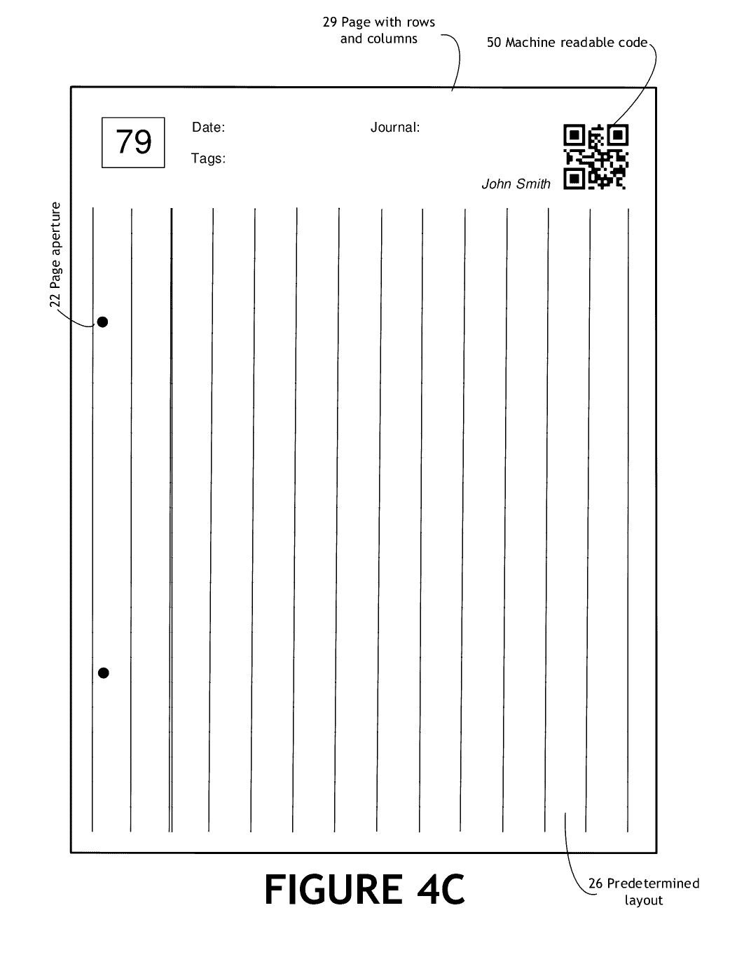

FIG. 5 depicts the preferred embodiment for capturing the handwritten data of a user into the matrix journal of FIG. 1.

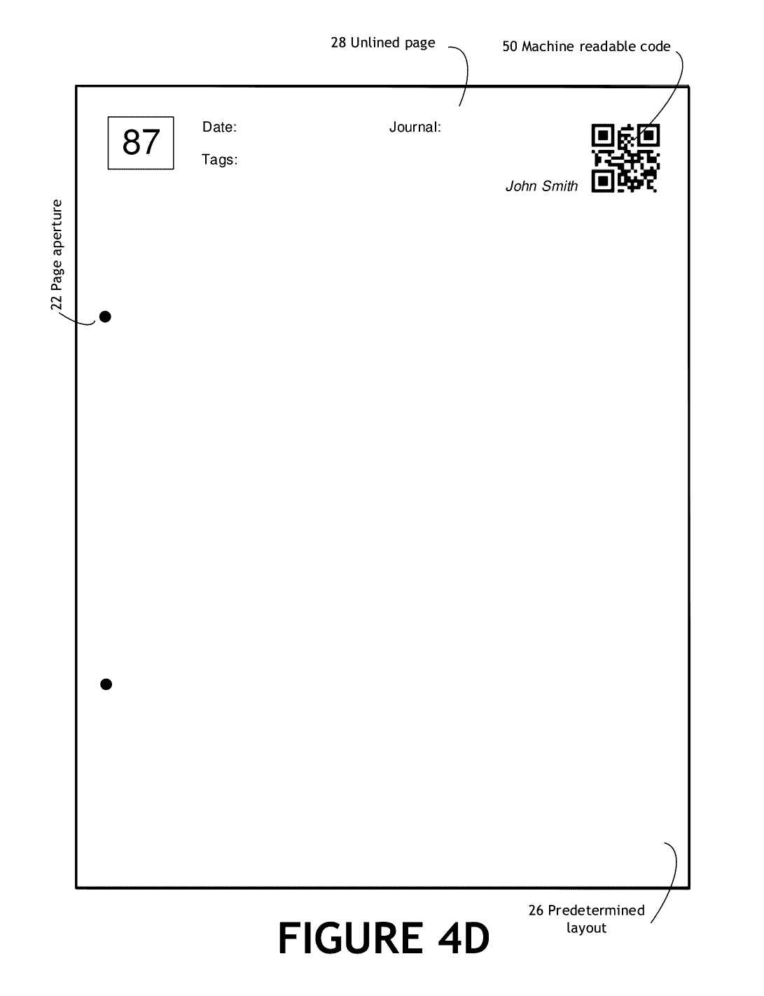

FIG. 6 depicts the preferred embodiment for capturing the handwritten data the matrix journal of FIG. 5 into the database for subsequent organization and management. Once entered into the database, a user captures page metadata machine readable information using an electronic device.

The user then enters handwritten data into the matrix journal. A pen is the preferred stylus for entering data, but a pencil may also be used. The user dates each page. The user may use different color ink if additional notes are later entered on the page. Brackets or other special characters can be used to sign in and sign out. Once a number of pages have been completed, the pages are scanned as database records. Once entered into the database, the computer is used for searching through the pages entered via the machine-readable codes. The database can be shared on the Internet or an Intranet for distribution to a wide range of devices. The user captures page metadata machine readable information using an electronic device. Page metadata is used to associate other information with the database record. Page metadata is used to link two or more pages. Page metadata data may be liked to current location. Page metadata can be lined to current time and date. Page metadata can associate additional key word tags and other reference notes.

The matrix journal of the present invention provides a binder that is reversible, so that either side may be used with equal advantages, the reversal being accomplished by opening the binder 360 degrees and then positioning it to access either the back of the exposed forward loose-leaf page or front of the exposed latter page, whereby either or both sides of a page may be written upon. In addition, the matrix journal of the present invention provides a binder which always presents a flat writing surface including when the front cover is opened 180 or 360 degrees relative to the back cover, and the whole surface of the current loose-leaf page is flat and can be used from edge to edge and top to bottom.

Some of the advantages of the matrix journal of the present invention [10] are (1) improving Paper integration into a Digital World: (2) Helps automatically organize scanned documents into searchable content; (3) improved record keeping, improved paper trail organization; (4) printout forms that can be used for handwritten feedback and logging; and (5) custom marketing solution: Evernote (“Evernote” is a registered trademark of Evernote Corp., Franklin Planner, and other organizer companies

Each loose-leaf page of the matrix journal of the present invention [10] includes a machine-readable code [50] unique to the page [20]. The machine-readable code [50] is entered onto each page when the matrix journal is initially created and includes such information as date, page number, serial number for each journal or page, company name, copyright information, website address, personalized name and contact information, project name, and team members.

Scan and read QR code to create pdf document integration into an organized filing system. The scanner is preferably a desktop scanner but other digitizing methods may also be used.

Additional option include the creation of layouts that are bilingual or even multilingual. Additional pages layouts could be calendars (weekly or monthly), the incorporation of reference materials (e.g.—periodic table, websites). Additional aspects—a mini-note paper with binding, integrate pen holder into cover, laser cut custom covers.

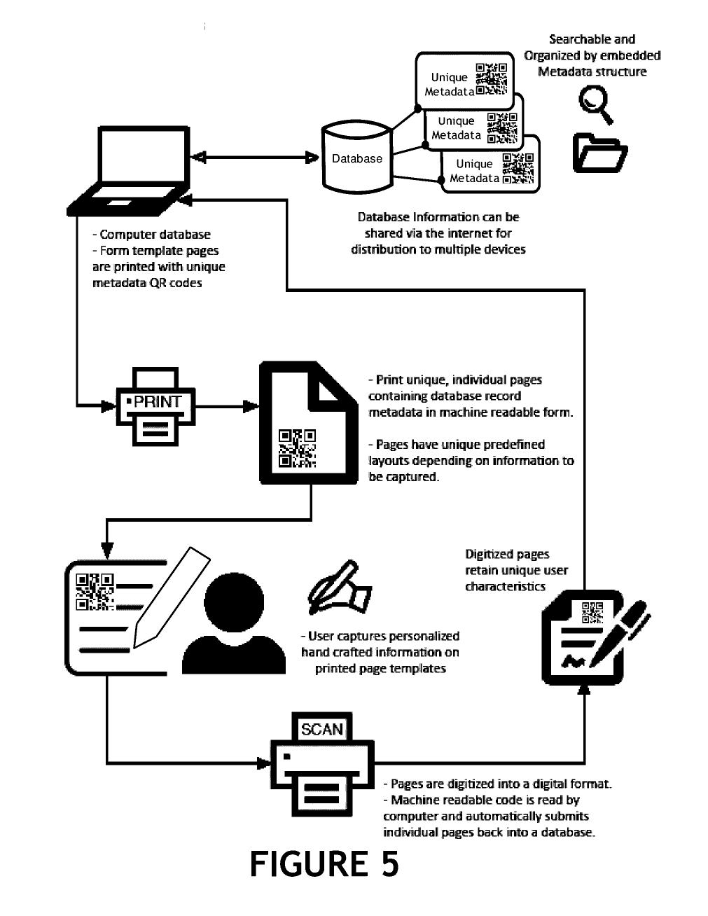

FIG. 7 is a simplified flowchart for a method of creating, using, and storing the journal pages of the present invention.

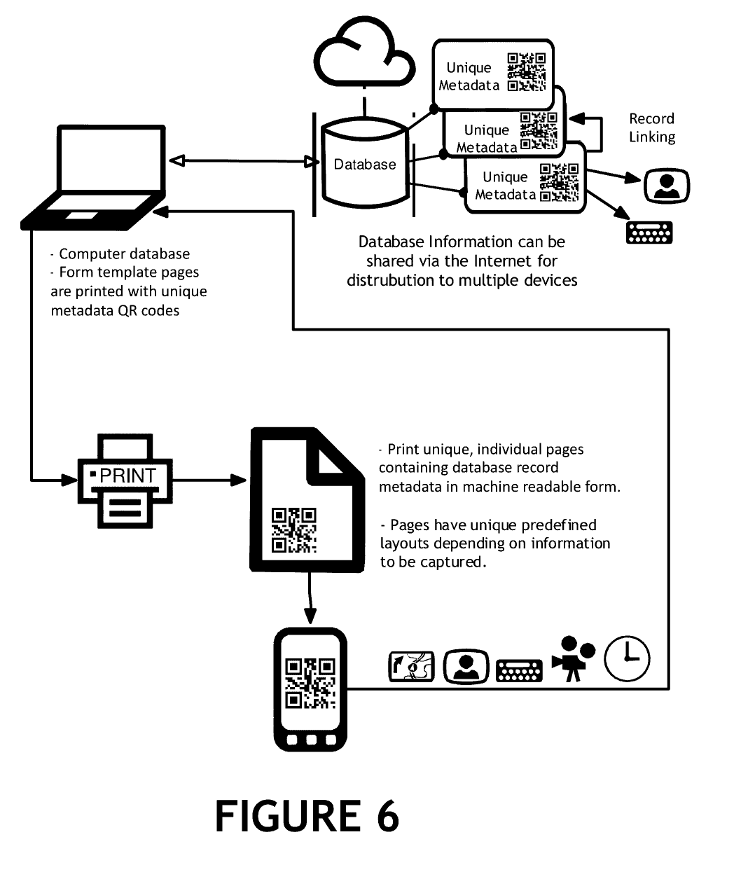

FIG. 8 shows a flowchart for a method of creating, using and storing the journal pages of the present invention. The method begins at step [110] with individual journal pages being printed, each page containing database record metadata in machine-readable form. The metadata can be either user-generated or automatically generated, and can include a variety of information including, but not limited to, page number, total number of pages in the journal, name of the journal owner, company name, and date. The metadata on each page also contains a unique identifier, such as a serial number. In a preferred embodiment, the machine-readable code is a two-dimensional bar code, such as a Quick Response (QR) code. The printed pages have predefined layouts depending on the type of information to be captured.

At step [120], the user captures personalized hand-crafted information on the printed page templates. This is accomplished through the use of traditional writing implements such as pens, pencils and markers, or any other method of marking on paper. At step

digital images of the journal pages are created using, for example, document scanners. Any other suitable method of creating digital images of documents can be used at this step as well, such as creating an image using a smart phone camera. At step [140], the machine-readable code is read by computer and automatically submits the individual pages back into a database.

The database is implemented to store, retrieve, and search the digital images of the journal pages, and is preferably a relational database, as is well known in the art, and uses Structured Query Language (SQL) as the language for querying and maintaining the database. Other database structures can be used as well. In the database, many functions can be performed on the digital images of the journal pages, such as searching, sorting and linking of documents. The functions are accomplished by using certain of the metadata contained in the machine-readable code. The information in the database can be shared via the Internet for distribution to multiple devices.

Structured Query Language (SQL) is a standard computer language for relational database management and data manipulation. SQL is used to query, insert, update and modify data. Most relational databases support SQL, which is an added benefit for database administrators (DBAs), as they are often required to support databases across several different platforms. First developed in the early 1970s at IBM, SQL was commercially released by Relational Software Inc. (now known as Oracle Corporation) in 1979. The current standard SQL version is voluntary, vendor-compliant and monitored by the American National Standards Institute (ANSI). Although most database systems use SQL, most of them also have additional proprietary extensions. However, the standard SQL commands such as “Select”, “Insert”, “Update”, “Delete”, “Create”, and “Drop” can be used to accomplish almost everything that one needs to do with a database.

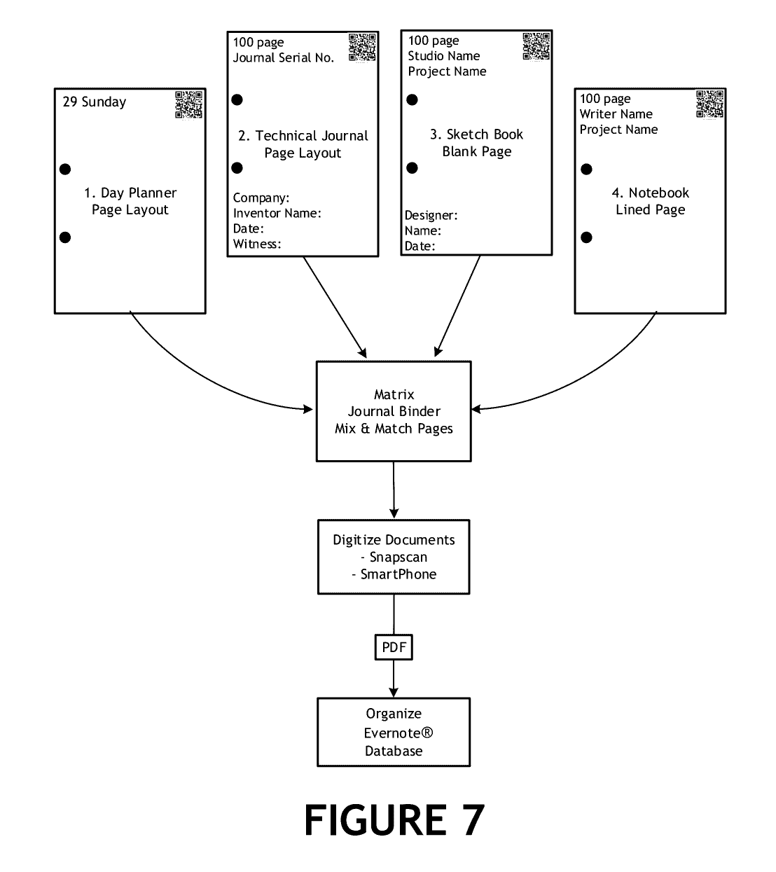

FIG. 9 depicts a flowchart for a method of linking additional content to digital copies of journal pages [20] in a database. The method begins at step [210] with individual journal pages being printed, each page containing database record metadata in machine-readable form. The metadata is either user-generated or automatically generated, and can include a variety of information including, but not limited to, page number, total number of pages in the journal, name of the journal owner, company name, and date. The metadata on each page also contains a unique identifier, such as a serial number. The printed pages have predefined layouts depending on the type of information to be captured.

At step [220], the user captures page metadata machine-readable information embedded in the QR code, preferably with a smart phone equipped with a camera, however other methods of capturing the QR code can be used. At this step the page metadata is used for a number of purposes, including associating other information with the database record, linking two or more pages, linking to the user's current location, linking to the current date and time, and associating additional keyword tags and other reference notes.

At step [230] the user sends the digital content to a database including the QR code. At step [240], the digital content becomes associated with the page metadata in the database. The page metadata is connected to both the digital content uploaded by the user, as well as the individual journal pages. This metadata, more specifically, the unique identifier contained in the metadata, is then used to link the digital content with the journal pages.

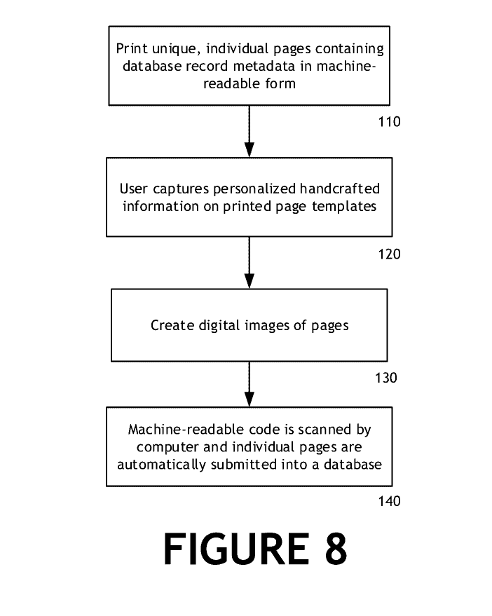

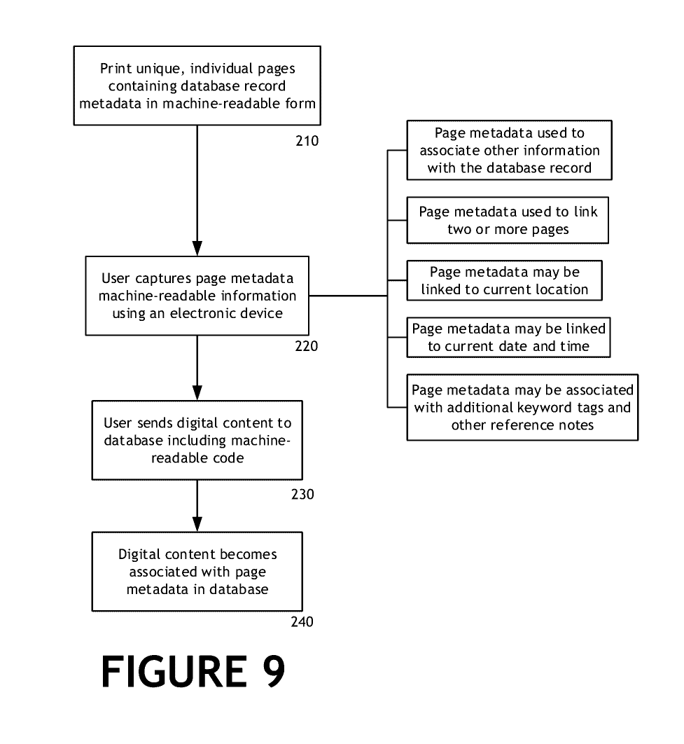

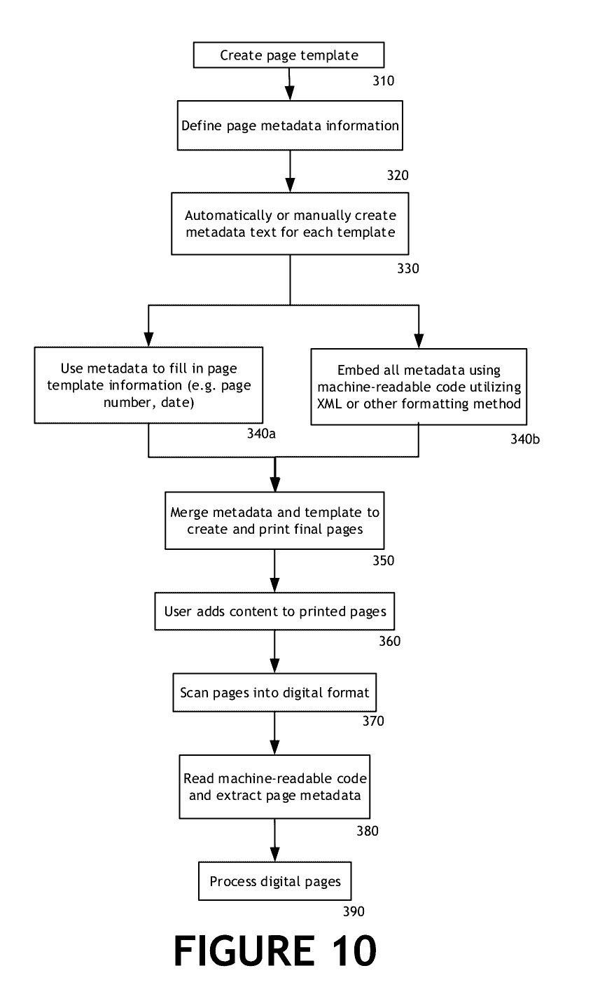

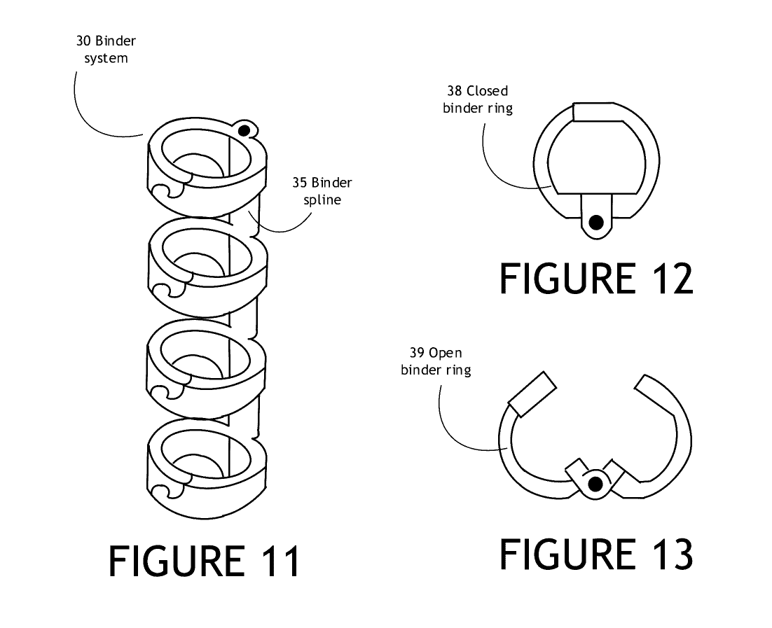

FIG. 10 depicts a flowchart of a method for the creation and use of the matrix journal of the present invention. At step [310], a page template is created. This can be done by either an end user or a third party entity. The pages can be created using appropriate software such as Adobe Illustrator, Microsoft Publisher, or any other software that can be used for this purpose. At step [320], the page metadata is defined. Again, this can be done by either an end user or a third party, and be either user-defined or automatically generated. The page metadata can contain any number of pieces of information, including, but not limited to, date, page number, serial number, company name, copyright information, website address, personalized name and contact information, project name, or any other custom tags the user may desire.

At step [330] the metadata text is automatically created from database or manually created using BBEdit, or any other appropriate text editor. At steps [340a] and [340b] the page metadata is used to fill in the page template information (such as page number, date, and time), and is embedded into the machine-readable code (QR code) utilizing XML tags, or other appropriate formatting method. At step [350], the metadata and page template are merged to create and print the final pages. Software such as BeLight Software: Labels Et Addresses can be used, or any other appropriate software that performs these functions.

In a preferred embodiment, steps [310-350] of FIG. 10 may be accomplished using a web-based interface. The interface enables a user to select page journal templates and other options, such as binding type, journal cover type, etc. The user would then select what metadata to include in the QR code printed on each page of the journal. An automated process would format the metadata, and the page templates would be created using the metadata. A Portable Document Format (pdf) document created enables the user to see a mock-up of the design and enable for a final review and sign-off. The pages could then be sent to a printer or an on-demand print service.

At step [360], the user captures personalized hand-crafted information on the printed page templates. This can be accomplished through the use of traditional writing implements such as pens, pencils and markers, or any other method of marking on paper. At step [370] digital images of the journal pages are created using, for example, document scanners. Any other suitable method of creating digital images of documents can be used at this step as well, such as creating an image using a smart phone camera. At step [380], the machine-readable code is read by computer and automatically submits the individual pages back into a database.

In all embodiments of the present invention, the database that is used to store digital images of journal pages is used to search and organize pages using the metadata structure embedded into the pages. In another preferred embodiment, the metadata is used to link pages together to simply associate them, or to collect them into a single document, and to link additional content to individual pages or groups of pages.

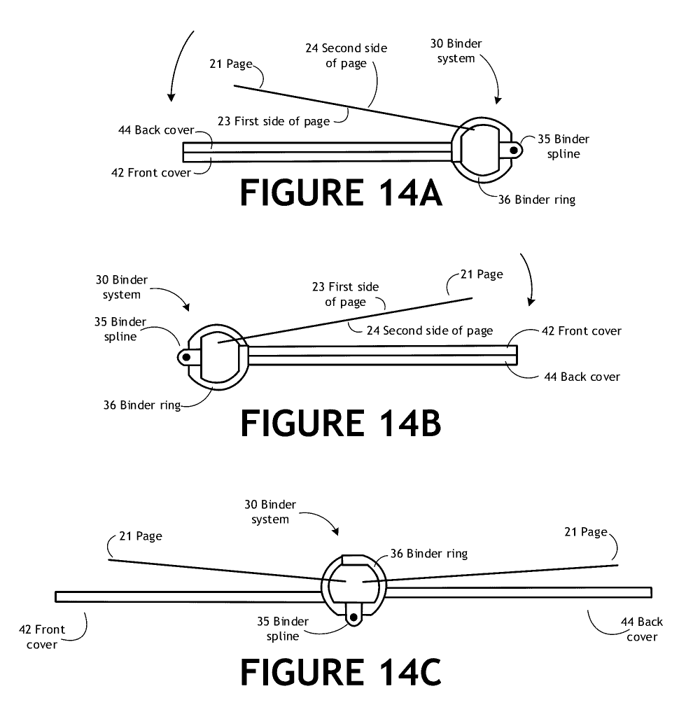

The journal ring binder mechanism readily locks when the ring members are in the closed position for retaining loose-leaf pages and the ring members are easily opened when a page is to be inserted or removed. However, the binder, of choice, is shown in U.S. Patent Document No. 20120288322, and U.S. Pat. No. 8,500,356 (Tanaka et al.), since this binder can be used for entering data in a 360-degree-flipped state, where the front cover abuts the rear cover in a compact manner as depicted in FIGS. 14A, 14B, and 14C.

FIG. 14A is an end view of the binder and the front cover [42] and the back cover [44] and the page [21] of the matrix journal of the present invention [10] in an open position. When the first side [23] of the page [21] moves to rest against the front cover [42 ] and the back cover [44], a hard support surface is provided enabling use of the matrix journal of the present invention [10] anywhere.

FIG. 14B is an end view of the binder and the front cover [42] and the back cover [44] and the page [21] of the matrix journal of the present invention [10] in an open position. When the second side [24] of the page moves to rest against the back cover [44] and the front cover [42], a hard support surface is provided enabling use of the matrix journal of the present invention [10] anywhere.

FIG. 14C is an end view of the front cover [42] and the back binder cover [44] and two pages of the matrix journal of the present invention [10] in a 180-degree half-flipped position for lying on a horizontal surface.

Cover designs that enable the front cover and back cover to fold in flat formations when open 360 degrees while simultaneously enabling the rings to rotate around an edge of the flatly-folded cover. The spine of skeleton axially disposed relative to rotation of rings and oppositely rotating back cover when the binder is open 360 degrees. Attachment of the middle cover to back cover so that the covers do not interfere with rotation of the rings when the binder is opened 360 degrees. Attachment of skeleton to cover in a way that enables the front cover to lie flat on the back cover while the binder is open at least 350 degrees, and preferably 360 degrees.

The binder system [30] of choice is a reversible binder. The reversal is accomplished by opening the binder substantially 360 degrees and then positioning the binder to access either the back of the exposed page or the front of the exposed page, whereby either side of the page may be written upon while always providing abutting a flat writing surface, the front or back cover.

The leaf bound by the binding device can be used for writing or otherwise in such a manner that the leaf is flipped over to the axis portion side and a leaf front side a and a leaf reverse side abut each other with the binder sandwiched there between when the leaves are laid during closing.

Throughout this application, various Patents are referenced by number and inventor. The disclosures of these documents in their entireties are hereby incorporated by reference into this specification in order to more fully describe the state of the art to which this invention pertains.

It is evident that many alternatives, modifications, and variations of the matrix journal of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

10 Matrix journal

20 Blank page with personalized heading

21 Page

22 Page aperture

23 First side of page

24 Second side of page

25 Index page

26 Predetermined layout

27 Lineated page

28 Unlined page

29 Page with rows and columns

30 Binder system

35 Binder spline

36 Binder ring

38 Closed binder ring

39 Open binder ring

42 Front cover

44 Back cover

50 Machine readable code

I claim:

1. A matrix journal comprising:
a binder system including a binder spline, and a plurality of binder rings;
a front cover and a back cover secured to said binder system;
a loose-leaf page including a first side and a second side, said loose-leaf page including a plurality of apertures enabling said loose-leaf page to be inserted or removed from said binder system between said front and back covers, said binder system retaining said leaf page to enable addition or removal of said loose-leaf page, said loose-leaf page being designed for entry of user-created handwritten data in a user handwriting, said first side of said loose-leaf page including a first machine-readable code unique to said first side, said first machine-readable code including a first unique predefined metadata depending upon information to be captured on said first side, said second side of said loose-leaf page including a second machine-readable code unique to said second side, said second machine-readable code including a second unique predefined metadata depending upon information to be captured on said second side, a first predefined layout depending upon information to be captured on said first side, a second predefined layout depending upon information to be captured on said second side; and
whereby said binder system provides at least a 350 degree rotation between said front and back covers thereby always providing a flat writing surface of said back cover for said first side of said loose-leaf page and said front cover for said second side of said loose-leaf page without removing said loose-leaf page from said binder system; and
whereby once handwritten data has been entered onto said page, said page is scanned into a database, said database preserving a digital version of said user-created handwritten data and said first and second machine-readable codes, enabling organization and management of digital versions of said loose-leaf page.

2. The matrix journal of claim 1, wherein said bind binder system further comprises an opening-closing mechanism including a lever so as to be opened and closed about the respective pivot portions provided in the lower ends thereof by rotationally moving said lever.

3. The matrix journal of claim 1, wherein said machine-readable code is a Quick Response (QR) code.

4. The matrix journal of claim 1, wherein a stylus is used to enter data.

5. The matrix journal of claim 1, wherein said database is shared via Internet or Intranet for distribution to multiple users.

6. The matrix journal of claim 1, wherein said first metadata embedded in said first machine-readable code and said second metadata embedded in said second machine-readable code is selected from the group consisting of date, page number, serial number for each journal or page, company name, copyright information, website address, personalized name, contact information, and project name.

7. The matrix journal of claim 1, wherein audio or video data is linkable with said database.

8. A method of organizing a digital copy of a handwritten journal, said method comprising:
providing a matrix journal, said matrix journal including a loose-leaf page, said loose-leaf page including a first side and a second side, said matrix journal including a binder system secured to a front and back cover, said loose-leaf page being designed for entry of user-created data in a user handwriting, said binder system enabling at least a 350 degree rotation between said front cover and said back cover, said binder system thereby always providing a flat writing surface of said back cover for said first side of said loose-leaf page and said front cover for said second side of said loose-leaf page without removing said loose-leaf page from said binder system, said first side of said loose-leaf page including a first machine-readable code unique to said first side, said first machine-readable code including a first unique predefined metadata depending upon information to be captured on said first side, said second side of said loose-leaf page including a second machine-readable code unique to said second side, said second machine-readable code including a second unique predefined metadata depending upon information to be captured on said second side, a first predefined layout depending upon information to be captured on said first side, a second predefined layout depending upon information to be captured on said second side; and
capturing handwritten data from said first side and said second side of said loose-leaf page;
creating a digital copy of said handwritten data and storing said digital copy in a database;
enabling organization and management of digital versions of said loose-leaf page by data stored in said first and second machine-readable codes.

9. The method of claim 8, wherein said machine-readable code is a Quick Response (QR) code.

10. The method of claim 8, further comprising adding a link to audio or video media with said database.

11. The method of claim 8, further comprising organizing and managing of said loose-leaf pages in said database in said handwriting of said user.

12. The method of claim 8, wherein said loose-leaf page is removed from said binder system prior to scanning into said database.

13. The method of claim 8, further comprising deploying said handwritten journal to generate .pdf documents.

14. The method of claim 8, further comprising deploying said handwritten journal to create specific notebooks by project.

15. The method of claim 8, further comprising deploying said handwritten journal to embed calendar pages into virtual calendars for history reference.

16. A loose-leaf page for a matrix journal, said page comprising a first side of a loose-leaf page and a second side of a loose-leaf page, a plurality of apertures disposed within a loose-leaf page enabling said loose-leaf page to be inserted and removed from between a front and back cover of a binder system, said binder system providing at least a 350 degree rotation between said front and back covers thereby always providing a flat writing surface of said back cover for said first side of said loose-leaf page and said front cover for said second side of said loose-leaf page without removing said loose-leaf page from said binder system, said first side of said loose-leaf page including a first machine-readable code unique to said first side, said first machine-readable code including a first unique predefined metadata depending upon information to be captured on said first side, said second side of said loose-leaf page including a second machine-readable code unique to said second side, said second machine-readable code including a second unique predefined metadata depending upon information to be captured on said second side, a first predefined layout depending upon information to be captured on said first side, a second predefined layout depending upon information to be captured on said second side;
whereby once handwritten data has been entered onto said page, said page is scanned into a database, said database preserving a digital version of said user-created handwritten data and said first and second machine-readable codes, enabling organization and management of digital versions of said loose-leaf page.

17. The page for said matrix journal of claim 16, wherein If said information to be captured on said first or second side of said page is a narrative, said predefined layout of said first or second side of said page is delineated, If said information to be captured on said first or second side of said page are for drawings or sketches, said predefined layout of said first or second side of said page is primarily blank, and If said information to be captured on said first or second side of said page are for financial data, said predefined layout of said first or second side of said page are rows and columns.

18. The page for said matrix journal of claim 16, wherein a first side of said page includes a handwritten date entered by said user.

19. The page for said matrix journal of claim 16, wherein said machine-readable code is a Quick Response (QR) code.

20. The page for said matrix journal of claim 16, wherein audio or video data is linkable with said database.
